(19) United States
(12) Patent Application Publication
(10) Pub. No.: US 2022/0314166 A1
(43) Pub. Date: Oct. 6, 2022

(54) Catalysts for NOx reduction and sulfur resistance

(71) Applicant: FU ZHOU UNIVERSITY, Minhou Fujian (CN)

(72) Inventors: Yuying ZHENG, Minhou Fujian (CN); Weijie ZHENG, Minhou Fujian (CN)

(73) Assignee: FU ZHOU UNIVERSITY, Minhou Fujian (CN)

(21) Appl. No.: 17/281,912

(22) PCT Filed: Jul. 10, 2020
(86) PCT No.: PCT/CN2020/101198

§ 371 Date: Mar. 31, 2021

(30) Foreign Application Priority Data
Dec. 25, 2019 (CN) 201911357552.7

(51) Int. Cl. B01D 53/86; B01J 23/00; B01J 23/34; B01J 37/02; B01J 37/08; B01J 35/00; B01J 6/00

(52) U.S. Cl. CPC B01D 53/8628; B01J 23/002; B01J 23/34; B01J 37/0236; B01J 37/08; B01J 35/008; B01J 6/001; B01J 2523/3712; B01J 2523/43; B01J 2523/72; B01D 2255/40; B01D 2257/40; B01D 2258/06

(57) ABSTRACT

The present invention belongs to the technical field of functional organic macromolecule composite catalysts and involves the preparation of a nitrogen-doped lattice macromolecule composite loaded with an efficient denitrification and sulfur resistance catalyst, firstly using the method of adding metal salts to make a large amount of Ce³⁺, Ce⁴⁺, Sn³⁺ and Sn⁴⁺ ions accumulate around the cyanuric acid molecule. Afterwards, 2,4,6-triaminopyrimidine and cytosine were added to graft with the cyanuric acid to produce the N-doped macromolecule in the first stage. After that, potassium permanganate was used as the oxidizing agent, and redox reaction occurred on the surface of N-doped macromolecules, so that the manganese cerium tin catalyst was grown in situ on the surface of N-doped macromolecules, and finally calcined at once to cross-link the N-doped macromolecules to generate catalyst composites. The catalysts described in this invention have higher efficient NOx reduction and sulfur resistance performance.

### BACKGROUND OF THE INVENTION

### Technical Field

The present invention belongs to the technical field of functional organic macromolecule composite catalysts, and particularly relates to the preparation of a novel N-doped organic macromolecule and the in situ growth of ternary Mn—Ce—SnOx catalysts on its surface for efficient NOx reduction and sulfur resistance catalysts.

### Description of Related Art

With the rapid development of industrialization, accompanied by the production of many unavoidable pollution, of which air pollution is the most serious and most concerned about the many pollution problems, air pollution has led to people's life, health, work and nature have suffered worse damage. At present, air pollution sources can be divided into fixed sources and mobile sources of pollution, the pollutants are mainly due to coal combustion, including PM2.5, PM10, sulfur dioxide, nitrogen oxides and nitrogen dioxide, these gases can cause haze, acid rain, photochemical smog and the greenhouse effect on the environment and other hazards.

Graphitic phase carbon nitride (g-C₃N₄) is the most stable carbon nitride at room temperature, and with a band gap of 2.7 eV, g-C₃N₄ can catalyze many reactions using visible light, such as photolysis of water, CO₂ reduction, air purification, degradation of organic pollutants, and synthesis of organic compounds.

Currently commercially available catalysts with vanadium and titanium systems have high starting temperatures (>300° C.), making them difficult to apply at the end of flue gas treatment systems and expensive to install and operate. Therefore, low-temperature selective catalytic reduction (SCR) technology, which is economical and suitable for end-of-pipe treatment, has become a hot topic of interest for researchers. The carrier-free MnOx-CeO₂ catalyst is the most active low-temperature SCR of this kind reported so far, and NOx can be almost completely converted to N₂ at a temperature of 120° C. However, there is no suitable technology to successfully grow it in situ on lattice macromolecules (referred to as g-C₃N₄).

### SUMMARY OF THE INVENTION

The purpose of the present invention is to provide a method for the preparation of highly efficient NOx reduction and sulfur resistance ternary catalysts grown in situ on homemade N-doped lattice macromolecules. In this method, the catalyst can be grown on the surface of the homemade N-doped lattice macromolecule in one step, and the in situ growth method results in a uniform and strong loading of the ternary catalyst on the surface of the lattice macromolecule.

In order to achieve the above purpose, the present invention adopts the following technical solutions:

Highly efficient composites of Mn—Ce—SnOₓ/TAP-CA-C NOx reduction and sulfur resistance catalysts were prepared by in-situ growth method using home-made N-doped lattice macromolecules as catalyst carriers. Firstly using the method of adding metal salts to make a large amount of Ce³⁺, Ce⁴⁺, Sn³⁺ and Sn⁴⁺ ions accumulate around the cyanuric acid molecule. Afterwards, 2,4,6-triaminopyrimidine and cytosine C were added to graft with the cyanuric acid to produce the N-doped macromolecule in the first stage. After that, potassium permanganate was used as the oxidizing agent, and redox reaction occurred on the surface of N-doped macromolecules, so that the manganese cerium tin catalyst was grown in situ on the surface of N-doped macromolecules, and finally calcined at once to cross-link the N-doped macromolecules to generate catalyst composites.

The above method of preparing the catalyst for NOx reduction and sulfur resistance, comprising the steps of:

Step 1: adding cerium acetate Ce(Ac)₃ to the configured solution of cyanuric acid CA solution and stirring for 1 hour at room temperature until Ce(Ac)₃ is completely dissolved; at this time, Ce³⁺ is seized to the CA surface through a dehydration condensation reaction.

Step 2: weighing tin tetrachloride SnCl₄, adding it to the step 1 solution, and continuing to stir at room temperature for 1 hour until SnCl₄ is completely dissolved; at this time, the CA surface is filled with the products of the reaction between Sn⁴⁺ and Ce³⁺.

Step 3: accurately weighing 0.075 g of 2,4,6-triaminopyrimidine TAP and adding it to the solution obtained in step 2, then adding 0.025 g of cytosine C and react at room temperature for 1 h, then adding KMnO₄ solution, continue the reaction at room temperature for 1 h, transferring the reaction solution to a surface dish after the reaction is finished, after which it is dried in an oven.

Step 4: calcining of the dried sample from step 3 in a high-temperature tube furnace to obtain the final latticed organic-like macromolecular-based catalyst composites labeled as Mn—Ce—SnOₓ/TAP-CA-C.

The CA solution in step 1 was prepared by accurately weighing 0.1 g of CA sample of cyanuric acid, dissolving it in 50 mL of N,N-dimethylformamide solvent, placing it in a sonicator for 30 min, and preparing the CA solution.

The molar ratio of CA to Ce(Ac)₃ in step 1 was any one of 1:0.1, 1:0.2, 1:0.3 and 1:0.4.

When the molar ratio of cyanuric acid to cerium acetate is 1:0.3, the composite has high NOx reduction ratio and sulfur resistance effect.

The molar ratio of SnCl₄ to Ce(Ac)₃ in step 2 is 1:1.

The molar ratio of Ce(Ac)₃ to KMnO₄ is 1:1.

The oven temperature as described in step 3 is 102° C.

The calcination described in step 4 is specifically calcined at 550° C. for 2 h.

The nitrogen-doped lattice macromolecule in situ grown NOx reduction and sulfur resistance catalysts prepared by the described method achieved good NOx reduction and sulfur resistance performance at catalyst loadings greater than 5 mg/cm2 and a molar ratio of CA to Ce(Ac)ₕ of 1:0.3.

The present invention has the following significant advantages:

1. Mn-based monolithic NOx reduction catalysts are easily poisoned by SO₂ to produce MnSO₄, which leads to catalyst denaturation and deactivation, resulting in a significant decrease in the NOx reduction ratio, and even almost loss of NOx reduction and sulfur resistance performance. However, the method of the present invention has in situ growth of rare earth elements Ce and Sn on the surface of the self-made graphite-phase carbon nitride, thus making it have better sulfur resistance performance.

2. The homemade N-doped lattice macromolecule in situ grown catalyst of the present invention has higher specific surface area, surface defects and more N elements, all of which are favorable to the NOx reduction and sulfur resistance reaction. Therefore, it has higher NOx reduction and sulfur resistance performance than the simple catalyst product.

3. The overall synthesis of the present invention is carried out in a low temperature environment, the reaction synthesis method and operation are simple, and its reaction is fast, there is no specific requirement for the reaction vessel, the synthesized material is not polluting to the environment. The catalytic component in the synthesized catalyst of the present invention is firmly bonded with the graphitic phase carbon nitride, and the catalyst has a long service life and a high demineralization rate.

### BRIEF DESCRIPTION OF THE DRAWINGS

FIG. 1 shows a diagram of the homemade tubular SCR reactor setup for catalyst activity testing.

In the figure, 1 is the vapor source; 2 is the pressure reducing valve; 3 is the mass flow meter; 4 is the mixer; 5 is the air preheater; 6 is the catalytic bed; 7 is the composite material; 8 is the flue gas analyzer.

FIG. 2 shows the scanning electron micrograph of the sample at the molar ratio of CA to Ce(Ac)₃ of 1:0.3.

FIG. 3 shows the catalytic stability analysis.

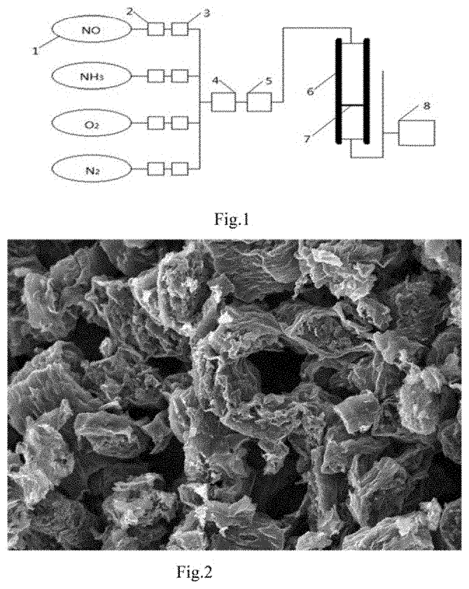

### DETAILED DESCRIPTION OF EMBODIMENTS

The present invention will be further described below in combination with the drawings and specific embodiments, but the protection scope of the present invention is not limited this.

### Example 1

A sample of 0.1 g of cyanuric acid (abbreviated as CA) was weighed, dissolved in 50 mL of N,N-dimethylformamide solvent, placed in a sonicator for 30 min, and prepared as CA solution. Then weigh 0.024 g of cerium acetate (abbreviated as Ce(Ac)₃) and add it to the configured above solution, and stir for 1 hour at room temperature until Ce(Ac)₃ is completely dissolved. After complete dissolution, weigh 0.027 g of tin tetrachloride (SnCl₄), add to the above solution and continue to stir at room temperature for 1 hour until SnCl₄ is completely dissolved.

After complete dissolution, weigh 0.075 g of 2,4,6-triaminopyrimidine (TAP) into the above solution, then add 0.025 g of cytosine (C) and react for 1 h at room temperature.

Then 0.012 g of KMnO₄ was dissolved in 30 mL of N,N-dimethylformamide, sonicated for 10 min and added to the above reaction solution, and the reaction was continued at room temperature for 1 h.

After the reaction, the reaction solution was transferred to a surface dish, followed by drying in an oven at 102° C. The dried sample was placed in a high temperature tube furnace and calcined at 550° C. for 2 h to obtain the final catalyst to be tested.

The mass of cerium acetate was calculated as follows: 0.1+129×0.1×317=0.024 g; the mass of tin chloride was calculated as follows: 0.024+317×350.6=0.027 g; the concentration of potassium permanganate was calculated as follows: 0.024+317×158=0.012 g.

The NOx reduction and sulfur resistance performance of the obtained catalysts were evaluated in a homemade tubular SCR reactor with NO and NH₃ volume fraction of 0.05%, O₂ volume fraction of 5% and the rest as N₂, gas flow rate of 700 mL·min⁻¹. When the temperature was set to 140° C., the NOx reduction ratio was 57% measured by the UK KM940 flue gas analyzer; when the temperature was set to 160° C., the NOx reduction ratio was 71%; when the temperature was set to 180° C., the ratio of NOx reduction and sulfur resistance was 82%; the final NOx reduction ratio was basically stabilized at 58% when SO₂ was introduced at 180° C. for 30 min interval test.

### Example 2

A sample of 0.1 g of cyanuric acid (abbreviated as CA) was weighed, dissolved in 50 mL of N,N-dimethylformamide solvent, placed in a sonicator for 30 min, and prepared as CA solution. Then weigh 0.048 g of cerium acetate (abbreviated as Ce(Ac)₃) and add it to the configured above solution, and stir for 1 hour at room temperature until Ce(Ac)₃ is completely dissolved. After complete dissolution, weigh 0.054 g of tin tetrachloride (SnCl₄), add to the above solution and continue to stir at room temperature for 1 hour until SnCl₄ is completely dissolved.

After complete dissolution, weigh 0.075 g of 2,4,6-triaminopyrimidine (TAP) into the above solution, then add 0.025 g of cytosine (C) and react for 1 h at room temperature.

Then 0.024 g of KMnO₄ was dissolved in 30 mL of N,N-dimethylformamide, sonicated for 10 min and added to the above reaction solution, and the reaction was continued at room temperature for 1 h.

After the reaction, the reaction solution was transferred to a surface dish, followed by drying in an oven at 102° C. The dried sample was placed in a high temperature tube furnace and calcined at 550° C. for 2 h to obtain the final catalyst to be tested.

The mass of cerium acetate was calculated as follows: 0.1+129×0.2×317=0.048 g; the mass of tin chloride was calculated as follows: 0.048+317×350.6=0.054 g; the concentration of potassium permanganate was calculated as follows: 0.048+317×158=0.024 g.

The NOx reduction and sulfur resistance performance of the obtained catalysts were evaluated in a homemade tubular SCR reactor with NO and NH₁ volume fraction of 0.05%, O₂ volume fraction of 5% and the rest as N₂, gas flow rate of 700 mL·min⁻¹. When the temperature was set to 140° C., the NOx reduction ratio was 61% measured by the UK KM940 flue gas analyzer; when the temperature was set to 160° C., the NOx reduction ratio was 75%; when the temperature was set to 180° C., the ratio of NOx reduction and sulfur resistance was 86%; the final NOx reduction ratio was basically stabilized at 60% when SO₂ was introduced at 180° C. for 30 min interval test.

### Example 3

A sample of 0.1 g of cyanuric acid (abbreviated as CA) was weighed, dissolved in 50 mL of N,N-dimethylformamide solvent, placed in a sonicator for 30 min, and prepared as CA solution. Then weigh 0.072 g of cerium acetate (abbreviated as Ce(Ac)₃) and add it to the configured above solution, and stir for 1 hour at room temperature until Ce(Ac)₃ is completely dissolved. After complete dissolution, weigh 0.081 g of tin tetrachloride (SnCl₄), add to the above solution and continue to stir at room temperature for 1 hour until SnCl₄ is completely dissolved.

After complete dissolution, weigh 0.075 g of 2,4,6-triaminopyrimidine (TAP) into the above solution, then add 0.025 g of cytosine (C) and react for 1 h at room temperature.

Then 0.036 g of KMnO₄ was dissolved in 30 mL of N,N-dimethylformamide, sonicated for 10 min and added to the above reaction solution, and the reaction was continued at room temperature for 1 h.

After the reaction, the reaction solution was transferred to a surface dish, followed by drying in an oven at 102° C. The dried sample was placed in a high temperature tube furnace and calcined at 550° C. for 2 h to obtain the final catalyst to be tested.

The mass of cerium acetate was calculated as follows: 0.1+129×0.3×317=0.072 g; the mass of tin chloride was calculated as follows: 0.072+317×350.6=0.081 g; the concentration of potassium permanganate was calculated as follows: 0.072+317×158=0.036 g.

The NOx reduction and sulfur resistance performance of the obtained catalysts were evaluated in a homemade tubular SCR reactor with NO and NH₃ volume fraction of 0.05%, O₂ volume fraction of 5% and the rest as N₂, gas flow rate of 700 ml·min⁻¹. When the temperature was set to 140° C., the NOx reduction ratio was 63% measured by the UK KM940 flue gas analyzer; when the temperature was set to 160° C., the NOx reduction ratio was 78%; when the temperature was set to 180° C., the ratio of NOx reduction and sulfur resistance was 91%; the final NOx reduction ratio was basically stabilized at 69% when SO₂ was introduced at 180° C. for 30 min interval test.

### Example 4

A sample of 0.1 g of cyanuric acid (abbreviated as CA) was weighed, dissolved in 50 mL of N,N-dimethylformamide solvent, placed in a sonicator for 30 min, and prepared as CA solution. Then weigh 0.096 g of cerium acetate (abbreviated as Ce(Ac)₃) and add it to the configured above solution, and stir for 1 hour at room temperature until Ce(Ac)₃ is completely dissolved. After complete dissolution, weigh 0.108 g of tin tetrachloride (SnCl₄), add to the above solution and continue to stir at room temperature for 1 hour until SnCl₄ is completely dissolved.

After complete dissolution, weigh 0.075 g of 2,4,6-triaminopyrimidine (TAP) into the above solution, then add 0.025 g of cytosine (C) and react for 1 h at room temperature.

Then 0.048 g of KMnO₄ was dissolved in 30 mL of N,N-dimethylformamide, sonicated for 10 min and added to the above reaction solution, and the reaction was continued at room temperature for 1 h.

After the reaction, the reaction solution was transferred to a surface dish, followed by drying in an oven at 102° C. The dried sample was placed in a high temperature tube furnace and calcined at 550° C. for 2 h to obtain the final catalyst to be tested.

The mass of cerium acetate was calculated as follows: 0.1+129×0.4×317=0.096 g; the mass of tin chloride was calculated as follows: 0.096+317×350.6=0.108 g; the concentration of potassium permanganate was calculated as follows: 0.096+317×158=0.048 g.

The NOx reduction and sulfur resistance performance of the obtained catalysts were evaluated in a homemade tubular SCR reactor with NO and NH₃ volume fraction of 0.05%, O₂ volume fraction of 5% and the rest as N₂, gas flow rate of 700 mL·min⁻¹. When the temperature was set to 140° C., the NOx reduction ratio was 59% measured by the UK KM940 flue gas analyzer: when the temperature was set to 160° C., the NOx reduction ratio was 71%; when the temperature was set to 180° C., the ratio of NOx reduction and sulfur resistance was 88%; the final NOx reduction ratio was basically stabilized at 61% when SO₂ was introduced at 180° C. for 30 min interval test.

Activity evaluation: The reactor in the homemade tubular SCR reactor was externally electrically heated, and thermocouples were placed next to the catalyst bed of the reactor tube to measure the temperature, and the flow of the experimental setup is shown in FIG. 1. The flue gas composition was simulated with a steel cylinder, including NO, O₂, N₂, NH₃ as reducing gases. NO and NH₃ were 0.04-0.06% by volume, O₂ was 4-6% by volume, the rest was N₂, and the gas flow rate was 700 mL·min⁻¹, the temperature was controlled between 120 The gas flow rate is 700 mL·min⁻¹, the temperature is controlled at 120-200° C., and the gas flow rate and composition are regulated and controlled by the mass flow meter. The gas analysis was carried out by KM940 flue gas analyzer from UK. To ensure the stability and accuracy of the data, each working condition was stabilized for at least 30 min.

TABLE 1
Effect of various factors on catalyst NOx reduction sulfur
resistance rate (reaction temperature of 180° C.).

| Experimental | | | | |
|---|---|---|---|---|
| conditions | Example 1 | Example 2 | Example 3 | Example 4 |
| The molar | 1:0.1 | 1:0.2 | 1:0.3 | 1:0.4 |
| ratio of CA to | | | | |
| Ce(Ac)₃ | | | | |
| The NOx | 82% | 86% | 91% | 88% |
| reduction ratio | | | | |
| The NOx | 58% | 60% | 69% | 61% |
| reduction ratio | | | | |
| when SO₂ was | | | | |
| introduced at | | | | |
| 180° C. for | | | | |
| 30 min interval | | | | |
| test | | | | |

From the data in Table 1, it can be seen that at 180° C., with the increasing mass ratio, the NOx reduction ratio along with the trend of increasing and then decreasing, and the maximum value appeared at the molar ratio of 1:0.3, and the NOx reduction sulfur resistance performance also reached the maximum value.

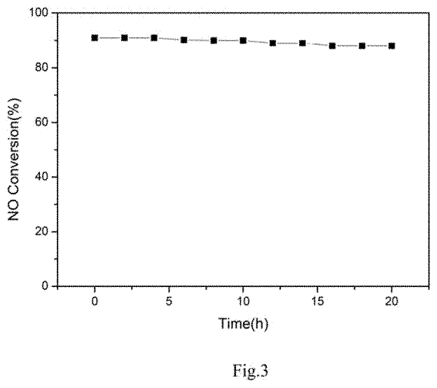

As can be seen from FIG. 3, the NOx reduction effect of the catalyst did not decrease significantly with the increase of catalytic reaction time, and it was stable at about 90%, indicating that the catalyst has good catalytic stability.

What is claimed is:

1. A method for preparing a catalyst for NOx reduction and sulfur resistance, characterized in that, a modified nitrogen-doped grid macromolecule as the catalyst carrier, the ternary Mn—Ce—SnOx catalyst in-situ growth on the surface of the nitrogen-doped grid macromolecule, wherein the method comprising the steps of:
Step 1: adding cerium acetate Ce(Ac)₃ to the configured solution of cyanuric acid CA solution and stirring for 1 hour at room temperature until Ce(Ac)₃ is completely dissolved; at this time, Ce³⁺ is seized to the CA surface through a dehydration condensation reaction;
Step 2: weighing tin tetrachloride SnCl₄, adding it to the step 1 solution, and continuing to stir at room temperature for 1 hour until SnCl₄ is completely dissolved; at this time, the CA surface is filled with the products of the reaction between Sn⁴⁺ and Ce³⁺;
Step 3: accurately weighing 0.075 g of 2,4,6-triaminopyrimidine TAP and adding it to the solution obtained in step 2, then adding 0.025 g of cytosine C and react at room temperature for 1 h, then adding KMnO₄ solution, continue the reaction at room temperature for 1 h, transferring the reaction solution to a surface dish after the reaction is finished, after which it is dried in an oven;
Step 4: calcining of the dried sample from step 3 in a high-temperature tube furnace to obtain the final latticed organic-like macromolecular-based catalyst composites labeled as Mn—Ce—SnOₓ/TAP-CA-C.

2. The method for preparing a catalyst for NOx reduction and sulfur resistance according to claim 1, wherein the CA solution in step 1 was prepared by accurately weighing 0.1 g of CA sample of cyanuric acid, dissolving it in 50 mL of N,N-dimethylformamide solvent, placing it in a sonicator for 30 min.

3. The method for preparing a catalyst for NOx reduction and sulfur resistance according to claim 1, wherein the molar ratio of CA to Ce(Ac)₃ in step 1 was any one of 1:0.1, 1:0.2, 1:0.3 and 1:0.4.

4. The method for preparing a catalyst for NOx reduction and sulfur resistance according to claim 1, wherein the molar ratio of CA to Ce(Ac)₃ in step 1 was 1:0.3.

5. The method for preparing a catalyst for NOx reduction and sulfur resistance according to claim 1, wherein the molar ratio of SnCl₄ to Ce(Ac)₃ in step 2 is 1:1.

6. The method for preparing a catalyst for NOx reduction and sulfur resistance according to claim 1, wherein the molar ratio of Ce(Ac)₃ to KMnO₄ is 1:1.

7. The method for preparing a catalyst for NOx reduction and sulfur resistance according to claim 1, wherein the oven temperature as described in step 3 is 102° C.

8. The method for preparing a catalyst for NOx reduction and sulfur resistance according to claim 1, wherein the calcination described in step 4 is specifically calcined at 550° C. for 2 h.

9. A catalyst for NOx reduction and sulfur resistance prepared by the method of claim 1.
